(19) United States
(12) Patent Application Publication
(10) Pub. No.: US 2022/0024793 A1
(43) Pub. Date: Jan. 27, 2022

(54) OXIDATION SYSTEM AND PROCESS FOR PHOTOCATALYTIC INDUCED POLYMERIZATION OF AROMATIC COMPOUNDS

(71) Applicant: Crystal Clear Environmental Pte. Ltd., Singapore (SG)

(72) Inventor: Shao Yang Frank CHEN, Singapore (SG)

(21) Appl. No.: 17/382,377

(22) Filed: Jul. 22, 2021

(30) Foreign Application Priority Data
Jul. 24, 2020 (SG) 10202007102W

(51) Int. Cl. C02F 1/72; C02F 1/32; C02F 1/00; C02F 1/76; C02F 1/52

(52) U.S. Cl. CPC C02F 1/725; C02F 1/325; C02F 2101/345; C02F 1/76; C02F 1/52; C02F 1/008

(57) ABSTRACT

The present application discloses a process for removing a substantial amount of phenolic compounds in waste water as solid substances. The present application also discloses an oxidation system for removing a substantial amount of phenolic compounds in waste water by the process of photocatalytic induced polymerization. The oxidation system includes a chemical dosing tank for adding a catalyst into the waste water; an ultraviolet (UV) reactor communicatively coupled to the chemical dosing tank for oxidizing the phenolic compounds into insoluble sediments; and a sedimentation tank communicatively coupled to the ultraviolet (UV) reactor for removing the insoluble sediments from the wastewater. The present application also discloses a process flow for removing the phenolic compounds in wastewater with the said system.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

The present application claims priority to Singapore Patent Application Nr. 10202007102W filed on 24 Jul. 2020. The entire contents of this preceding application is specifically incorporated by reference, wherever appropriate.

### FIELD OF THE INVENTION

The present application relates to a process for removing a substantial amount of phenolic compounds in production reject stream as a solid polymer as solid substances (such as insoluble macromolecules, oligomers and polymers). The present application also discloses an oxidation system for removing a substantial amount of phenolic compounds from waste water by the process of photocatalytic induced polymerization.

### BACKGROUND OF THE INVENTION

Functional aromatic compounds or functional aromatics (such as phenolic compounds) are widely found, from naturally occurring polyphenols in apples and wines to oxidation of functional aromatic compounds as monomers for polymerization processes in synthetic petrochemical industries. Current treatment technologies of wastewater (such as petrochemical reject streams) include physical separation technologies which generally make use of differences in density, dissolvability and particle sizes of foreign materials in the wastewater. For example, a high-speed centrifugal method is deployed to separate heavy materials (such as macromolecules or polymers with high molar weights) from the waste water. But the physical separation technologies are useful only if the foreign materials are dissolvable in water and have a significant molar weight difference to water. For another example, a dissolved-air-flotation method is commonly used to remove fine particles and oily substance from the wastewater solution. The dissolved-air-flotation method relies on micro-air bubbles which amplify difference in density between different substances in the water. In an oil-water separation case, oily substances usually have lower densities to water and thus would float to surface. The oily substances are subsequently removed physically by a mechanical scrapper, and the remaining solution has significantly less oily substances and small particles. Flocculants are commonly used in conjunction to promote separation. Since the phenolic compounds are soluble in water, particularly hot water, and has a comparable density with water (e.g., phenol has a density of 1.071 g/ml at 25° C.); and thus, the phenolic compounds cannot be removed from waste water with either the high-speed centrifugal method or the dissolved-air-flotation method. In addition, filtration method is also deployed for physical separation such as oil-water separation. Water is forced to flow through a series of small pore-sized filter membranes. Particles or molecules larger than 0.1 micron are rejected from a resultant effluent. Since the phenolic compounds are generally smaller than 0.1 micron, the filtration method is also not applicable.

Current treatment technologies of waste water also include biological treatment technologies which are cheaper in large scaled deployments. However, industrial waste water cannot be completely degraded since micro-organisms have an ability only to partially reduce toxic and/or complex organic compounds in the waste water. Therefore, waste water having a high concentration of phenolic compounds cannot be treated with the biological treatment technologies. It is generally acknowledged that waste water cannot be treated with phenolic compounds having a concentration more than 1500 parts per million (ppm). In addition, presence of high salinity or total dissolved salts in the wastewater is also retardant or even detrimental to the biological treatment of waste water. As a result, traditional incineration method is still employed for treating phenolic compounds. But harmful gases are produced from burning the phenolic compounds such as oxalic acids or alkene vapors.

In one of the exemplary conventional arts, a method for purifying waste water generated during an emulsion polymerization process for acrylonitrile butadiene styrene. The method involves steps of filtering, supplying an oxidizing agent, raising the pH from 8 to 12, separating the precipitate, followed by introducing the clarified waste water into a bioreactor involving acidification of the biologically treated water, and again increasing the pH before introducing the waste water to a reverse osmosis.

Current treatment technologies of waste water further include chemical treatment technologies in which functional aromatics are oxidized to simpler substances over time. However, the chemical treatment technologies are inefficient and require controlled environments, such as dry air, enclosed reactor and partial vacuum. In addition, the chemical treatment technologies may also use hazardous chemicals. Therefore, the chemical treatment technologies are not desirable to treating the phenolic compounds in wastewater.

Therefore, there exists a need for a system and a method for treatment of waste water such that the waste water is rid of phenolic aromatic compounds to a maximum extent.

### SUMMARY OF THE INVENTION

According to a first aspect, the present patent application provides an oxidation system for removing phenolic compounds from waste water. The oxidation system comprises a chemical dosing tank having a consumable catalyst added therein. The oxidation system preferably further comprises formation of insoluble chlorine complex polymers out of the phenolic compounds present in the wastewater due to addition of consumable catalyst. Particularly, the catalyst is chlorine-based and ultraviolet-activated.

In some embodiments, the oxidation system further comprises polymerization of the phenol-derived compounds and the unreacted phenolic compounds. Preferably, such polymerization may occur at temperature in the range of 45° C. and 55° C. Most preferably, such polymerization may occur at temperature in the range of 45° C. and 50° C.

The system also comprises an ultraviolet (UV) reactor communicatively coupled to the chemical dosing tank. The reactor further comprises a plurality of ultraviolet light sources. The ultraviolet light sources are configured to irradiate the reactor with the ultraviolet light. Advantageously, the UV (ultraviolet) light sources are configured to distribute evenly across the ultraviolet reactor for providing homogeneous photocatalytic oxidation of the phenolic compounds in the waste water. The reactor further comprises a controlling mechanism for controlling a lateral flow of the waste water across the reactor to a pre-determined speed, a controlled oxidation of the phenolic compounds into the phenol-derived compounds, followed by polymerization of the phenol-derived compounds and the unreacted phenolic compounds into insoluble sediments. The chemical dosing tank is configured to be positioned higher than that of the ultraviolet (UV) reactor enabling gravitational and lateral flow of the waste water from the tank into the reactor. The gravitational flow automates the flow of effluents from the tank into the reactor without requiring any additional resources. The system also comprises a sedimentation tank communicatively coupled to the ultraviolet (UV) reactor adapted to remove the insoluble sediments from the waste water.

The present application hence relates to removal of phenolic content from the waste water by creating a mixture of large phenolic polymeric solids through the course of photocatalytic-controlled oxidation. The present application also relates to more than 92% pure phenolic content, with total phenolic concentration ranging between 5 and 10%, while COD value is typically more than 10%, to a maximum recorded value of 22%. Hence the COD to phenolic ratio ranges between 2 and 3.5 times.

In an embodiment, the oxidation system can include or comprise a pre-treatment mechanism communicatively coupled before the chemical dosing tank.

The pre-treatment mechanism involves preliminary removal of foreign materials such as oil, grease, sand, and suspended solids from the wastewater. Such foreign materials have the tendency to reduce waste water treatment efficiency through clogging and wear. Hence, the pre-treatment mechanism prevents accumulation of such foreign materials, and minimizing the subsequent blockages. In another embodiment, the oxidation system comprising an effluent tank communicatively coupled to the sedimentation tank for temporarily storing treated effluent. A recycling mechanism communicatively coupled between the effluent tank and the chemical dosing tank for returning treated waste water back to the chemical dosing tank. The recycling mechanism facilitates the treatment of the treated waste water again to achieve the water of higher purity and remove more phenols if still left in the treated waste water. The recycling mechanism further facilitates testing of the purity of the treated waste water. For example, the treated waste water when recycled if gives same amount of purity and same % of phenol being removed therefrom upon testing, it means the water has been treated. The phenol-free water of higher purity may be used for various purposes like washing, sanitation, industrial purposes, etc. As a second aspect, the present application discloses a process for removing phenolic compounds from waste water. It is contemplated that sequence and number of the steps of the process provided hereinafter are exemplary in nature and provided for the purposes of persons skilled in the art to understand the present application. The process involves removing foreign materials such as including but not limited to solids, oily, grease, sand, or any suspended substances from the waste water before adding a catalyst into the waste water.

Further, the process includes adding a consumable catalyst into the waste water in the chemical dosing tank. More particularly, the process involves adding the consumable chlorine-based and UV-activating catalyst into the waste water in the chemical dosing tank. As the catalyst is consumed, there is no fouling, and no washing may be required in the oxidation system.

In addition, the process involves adding an acid solution into the waste water before exposing the waste water to the ultraviolet (UV) light. Thereafter, the process involves a series of chemical reactions of oxidizing the phenolic compounds into insoluble sediments under controlled ultraviolet (UV) light (photocatalytic oxidation) conditions. In particular, the UV (ultraviolet) reactor involves activating the catalyst by the ultraviolet (UV) light for generating hydroxyl radicals in the waste water. The hydroxyl radicals have oxidizing power enough to oxidize the phenolic compounds to phenolic derived compounds. More particularly, the hydroxyl radicals have oxidizing power of 2.5 electron-volts (Ev) to oxidize the phenolic compounds to phenolic derived compounds. Thereafter, the phenolic derived compounds and the remaining unreacted phenolic compounds undergo polymerization to form insoluble sediments. The insoluble sediments are subsequently removed from the waste water, turning the waste water into treated water. The process also involves adding flocculent agents to the treated water for clustering the insoluble sediments derived from the phenolic compounds in the waste water. Flocculent agents cause the insoluble sediments to form aggregates called flocs. The flocs may further drop out of the waste water.

The process further includes storing the treated water temporarily after removing the insoluble sediments from the waste water. The treated water can be recycled for removing the remaining phenolic compounds in the treated water.

In some embodiments, the process further comprises controlling a lateral flow of the waste water across the ultraviolet (UV) reactor to a pre-determined speed to provide the controlled oxidation of the phenolic compounds to the phenolic derived compounds. More particularly, the lateral flow of the waste water across the reactor to convert the phenolic compounds to quinones.

### BRIEF DESCRIPTION OF THE DRAWINGS

The accompanying figures (Figs.) illustrate embodiments and serve to explain principles of the disclosed embodiments. It is to be understood, however, that these figures are presented for purposes of illustration only, and not for defining limits of relevant applications.

FIG. 1 shows an absorption spectrum reflecting absorbance range of chlorine-oxygen bond targeted in perchloric acid or hypochlorous acid used as an oxidant to produce hydroxide radicals in the waste water;

FIG. 2 shows a schematic figure of a light source emitting ultraviolet (UV) light to water surface;

FIG. 3 illustrates a schematic diagram of a oxidation system for removing phenolic compounds in the waste water;

FIG. 4 illustrates a process flow of treating the waste water;

FIG. 5 illustrates a schematic diagram of testing flow of concentration of phenolic compounds in the waste water via ultraviolet (UV) spectrometer;

FIG. 6 illustrates a table of experimental results of the oxidation system;

and

FIG. 7 shows a photo of the experiment results.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

The present application utilizes a controlled oxidation by photocatalytic means (also known as controlled photocatalytic oxidation) of phenolic compounds to and subsequent chemical reactions of the phenolic compounds and the phenolic derived compounds (such as quinones) to produce relatively large, heavy and insoluble compounds which could be easily separated by the current treatment technologies (such as precipitation, centrifugation or filtration).

In particular, the present application discloses a process for polymerizing phenolic compounds through photocatalytic oxidation in which the phenolic compounds are firstly converted to phenolic derived compounds which would then polymerize with the unreacted phenolic compounds. More particularly, the present application discloses a series of reactions in which the phenolic compounds are firstly converted to quinones. The quinones further react with the unreacted phenolic compounds. The process results in large scale and a mixture of insoluble solid phenolic complexes which would be precipitated from the waste water.

As a first aspect, the present application discloses an oxidation system for removing phenolic compounds from waste water. The phenolic compounds include many types of phenolic hydrocarbons, including phenolic olefins and aromatic phenols. The oxidation system includes a chemical dosing tank for adding a catalyst into the waste water; an ultraviolet (UV) reactor communicatively coupled to the chemical dosing tank for oxidizing the phenolic compounds into insoluble sediments; and a sedimentation tank communicatively coupled to the ultraviolet (UV) reactor for removing the insoluble sediments from the waste water. Before the waste water flows into the chemical dosing tank, the waste water may undergo a pre-treatment process.

The oxidation system optionally includes a pre-treatment mechanism communicatively coupled before the chemical dosing tank for removing foreign materials from the waste water. The pre-treatment mechanism involves preliminary removal of foreign materials or waste water sludge constituents such as oil, grease, sand, and various solids such as sand, fibers, trash, etc. from the wastewater. Such foreign materials have the tendency to reduce waste water treatment efficiency through clogging and wear. In some implementations, the pre-treatment process involves blocking the introduction of pollutants into the waste water which have also the tendency to cause damage equipment, and interfering with the further steps of processing of the waste water treatment. There may be different ways through preliminary treatment can be done. Such ways can be categorized into mechanical, biological, chemical, physic-chemical, etc. For example, grease traps, oil/water separators, chemical neutralization, cyclone grit separators, etc. Hence, the pre-treatment mechanism prevents accumulation of such foreign materials, and minimizing the subsequent blockages.

Looping back to the chemical dosing tank. The tank defines a positive displacement pump which is designed such that a chemical or any other substance may be injected into a flow of stream, gas or water. Therefore, the chemical dosing tank provides an automatic injection of reagents into the waste water to run a series of reactions. For example, the tank may involve injection of sulfuric acid, etc. The dosing pump is configured for automatic dispersion of chemicals, therein. The dosing pump can be powered by an electric motor. In some instances, the dosing pump may be actuated by air. The dosing pump may be controlled by a controller to switch it on and off. Preferably, an injector in the tank is a one-way valve where the chemicals or catalyst may be injected into the tank.

In an implementation, demulsifier or coagulant may be dosed in the chemical tank. The coagulant may have higher tendency to form large clusters of phenolic polymers during UV lighting due to aldehyde functional groups present therein. Therefore, the resultant polymers are a mix of solid phenolic complexes which can be separated from the solution. There may be different types of coagulants employed for the purpose such as including but are not limited to aluminum coagulants such as aluminum sulfate, aluminum chloride, sodium aluminate; iron coagulants such as ferric sulfate, ferrous sulfate, ferric chloride, ferric chloride sulfate; titanium, zirconium, and so on.

In some implementations, a suitable amount of catalyst may be introduced into the chemical dosing tank. Such an introduction can be done either manually or via machinery. The catalyst would be activated by the ultraviolet (UV) energy to generate hydroxyl radicals in the waste water. The hydroxyl radical has a relative oxidizing power of 2.5 electron-volts (Ev) which is able to oxide the phenolic compounds to quinones, organic acids with carboxyl groups, or even small molecules such as carbon oxide and water. In some implementation, the catalyst includes a chlorine-based substance which has a fast chemical kinetics to generate enough hydroxyl radicals within limited treatment duration. The chlorine-based substances may include such as but are not limited to chloride, salts of chloride, and so on.

In particular, the phenolic compounds are substantially oxidized to quinones via a controlled photocatalytic oxidation of the phenolic compounds. The polymerization of the phenolic compounds and the quinones can be conducted in a temperature range of 45° to 55° C. in the waste water. More preferably, the polymerization occurs in a temperature range of 45° to 50° C. In particular, insoluble chlorine complexes would be formed out of the phenolic compounds present in the waste water, hence forming the polymers in the beginning. Therefore, the catalyst is consumed in the controlled photocatalytic reaction, and thus no fouling or washing may be needed in the oxidation system.

The ultraviolet (UV) reactor includes an ultraviolet (UV) light source for providing an ultraviolet (UV) light to the ultraviolet (UV) reactor. The reactor includes a plurality of ultraviolet (UV) light sources configured to activate the catalyst. Advantageously, the ultraviolet (UV) light sources are configured to distribute evenly across the ultraviolet (UV) reactor for providing homogeneous photocatalytic oxidation of the phenolic compounds in the waste water, producing uniform polymeric solids. In some embodiments, the UV (ultraviolet) light sources may be configured to distribute unevenly across the UV reactor for providing heterogenous photolytic oxidation of the phenolic compounds, producing a mix of polymeric solids. For a small system of the treatment of waste water, one UV (ultraviolet) lamp may be enough, however number of the lamps depend upon the volume of the waste water to be treated. For large systems for treating waste water, multiple UV (ultraviolet) light sources may be employed.

Under the ultraviolet (UV) light and the catalyst, some of the phenolic compounds in the waste water are oxidized by the hydroxyl radicals to quinones only in the ultraviolet (UV) reactor. Then, the quinones and the remaining phenolic compounds react to form oligomers and even polymers (also known as macromolecules) via condensation polymerization if the waste water stays in the ultraviolet (UV) reactor for a longer time. Large oligomers and polymers are not dissolvable or have low dissolvability with little mechanical perturbation in water and thus suspend in the waste water or even precipitate in the ultraviolet (UV) reactor. In other words, the phenolic compounds undergo a photocatalytic oxidation in the ultraviolet (UV) reactor. As a result, phenolic compounds in the waste water are largely removed and the waste water is thus turned into treated waste water. Many parameters of the ultraviolet (UV) reactor would influence the reaction (such as the polymerization) to produce the oligomers and the polymers, such as ultraviolet (UV) wavelength, intensity of the ultraviolet (UV) light, lighting distance and lighting duration. For example, wavelength of the ultraviolet (UV) light is selected to UVC spectrum (wavelength of 254 nm in the case that the chlorine-based substance is selected as the catalyst, since the chlorine-based substance has more bandgap absorption of the ultraviolet energy in the UVC and/or UVA spectra which is in favor of chemical kinetics to form hydroxyl radicals.

In particular, the ultraviolet (UV) reactor has a controlling mechanism to control an inflow stream of the waste water from the chemical dosing tank and an outflow stream of the treated waste water to the sedimentation tank. Thus, the controlling mechanism controls a lateral flow of the waste water across the ultraviolet (UV) reactor to a pre-determined speed in order to provide the controlled oxidation of the phenolic compounds to the quinones (intermediate product as shown in a reaction below), but not to other further oxidized compounds such as organic acids or small molecules such as carbon dioxide and water.

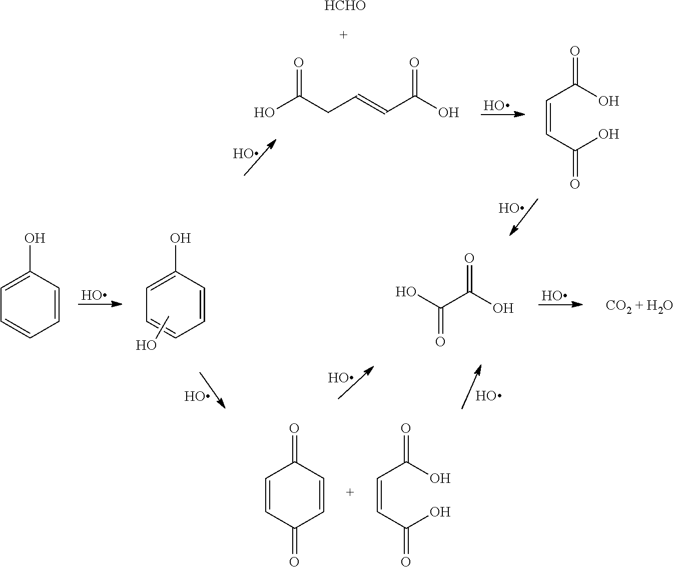

The outflow stream of treated waste water carries the suspended oligomers and polymers into the sedimentation tank. The suspended oligomers and polymers are removed from the treated waste water by any known physical separation technologies such as high-speed centrifugal method or filtration method.

The oligomers and polymers are then cleared from the sedimentation tank from time to time. In addition, the sedimentation tank may comprise a collecting mechanism for collecting the oligomers and polymers as chemical raw materials for further use. As a result, polymers derived from the phenolic compounds could be obtained from waste water (such as petrochemical waste water) for achieving economic benefits during treatment of the waste water. Before the waste water flows into the chemical dosing tank, a concentration of the phenolic compounds is tested with UV-visible (ultraviolet-visible) spectroscopy.

In particular, the controlled photocatalytic oxidation is fulfilled from three aspects in the present application: firstly, a lateral flow speed of the waste water across the ultraviolent reactor; secondly, wavelength selection and intensity of the ultraviolent (UV) light, lighting distance and controlling lighting duration throughout the reaction; and thirdly, an amount of catalyst introduced into the reaction.

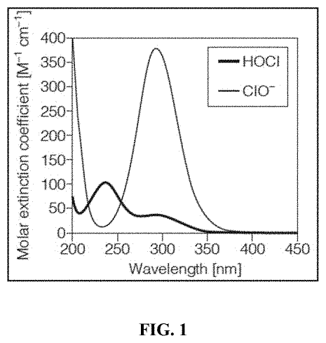

FIG. 1 shows an absorption spectrum reflecting absorbance range of chlorine-oxygen bond targeted in perchloric acid or hypochlorous acid used as an oxidant to produce hydroxide radicals in the waste water. The phenolic compounds show two distinct peaks in a region of 260 to 275 nm in the UV-visible spectroscopy if a weak acidic environment (pH in a range of 5.2 to 7) is established in the waste water.

In some implementations, a sulfuric acid (H₂SO₄) solution is provided to the chemical dosing tank. Since sulfuric acid has a strong absorption to ultraviolet (UV) light with a wavelength shorter than UVC spectrum, the ultraviolet (UV) light should be limited to UVA and UVC spectra for preventing any hindrance of the sulfonic acid to the reaction kinetics of the phenolic compounds and the quinones.

The oxidation system optionally includes an effluent tank communicatively coupled to the sedimentation tank for temporarily storing treated effluent. Concentration of the phenolic compounds in the treated effluent in the effluent tank is tested to determine whether the treated phenolic solution meets the requirement of the phenolic concentration to be discharged out. If not, the effluent would flow back for another or more cycle of treatments until the requirement is met in the effluent tank.

The oxidation system optionally includes a recycling mechanism communicatively coupled between the effluent tank and the chemical dosing tank for returning the treated effluent back to the chemical dosing tank. If the catalyst (such as the chlorine-based substance) is consumed or lost during the treatment, more catalyst would be added in the chemical dosing tank for another cycle of treatment. In addition, acidity of the waste water may be also adjusted if pH of the waste water falls out of the range of 5.2 to 7.

As a second aspect, the present application discloses a process for removing phenolic compounds from waste water. Some steps of the method may be combined, separated or changed in sequence. The process includes a first step of adding a catalyst (such as chlorine-based substance) into the waste water; a second step of oxidizing the phenolic compounds into insoluble sediments under ultraviolet (UV) light via a photocatalytic oxidation of the phenolic compounds; and a third step of removing the insoluble sediments (such as insoluble oligomers and polymers derived from the phenolic compounds) from the phenolic solution.

The third step of removing the insoluble sediments may comprise a procedure of adding a flocculent to the treated water. The flocculent would facilitate clustering of the insoluble oligomers and polymers derived from the phenolic compounds in the waste water. The flocculent may be any known types to fulfill the purpose, such as polyacrylamide (PAM) and multivalent cationic flocculants. Other examples of the flocculants may include such as but are not limited to ferric chloride, ferric sulfate, ferrous sulfate, aluminum sulfate, alum, ferric chloride, ferric sulfate, and so on.

The process may further include a procedure of testing a concentration of the phenolic compounds in the waste water before the first step and/or after the third step. In some implementations, the concentration is tested via ultraviolet-visible spectroscopy. Before the test, a calibration plot (such as a linear plot in a desirable way) is drawn by using standard sample with known phenolic compounds, and thus the concentration of the waste water could be deduced from the calibration plot. If the waste water has a higher concentration of the phenolic compounds beyond the calibration plot, the waste water would be diluted before the test of ultraviolet-visible spectroscopy.

A general monochromatic light penetration equation is shown as:

F(x)=F(x₀)e^{-α(x-x}^{₀}⁾

wherein F(x₀) represents an initial intensity of the monochromatic light at a surface x0 of a liquid or solution; F(x) represents an intensity of the monochromatic light at a depth x below the surface of the liquid or the solution; and α represents an absorption coefficient of the liquid or the solution, which determines the depth at which the monochromatic light of a certain wavelength penetrates through the liquid or the solution.

In addition to the certain wavelength of monochromatic light, the absorption coefficient κ is also related to an extinction coefficient which is also

$$α = \frac{4 π f κ}{c}$$

related to the wavelength of the monochromatic light. The extinction coefficient κ is an optical property of a semiconductor material and is related to an index of refraction n, which determines how much monochromatic light is absorbed by the semiconductor material. When κ>0, it means absorption of the monochromatic light, when κ=0, it means the monochromatic light travels straightly through the semiconductor material. The absorption coefficient α and extinction coefficient κ are related by the equation as:
wherein f represents a frequency of a monochromatic light, which is related to the wavelength in the equation λ=v/f, wherein v represents a velocity of the monochromatic light; c represents a speed of the monochromatic light, and π represents the constant (≈3.14).

Therefore, the general light penetration equation to is simplified as:

$$F ( {x}_{0} ) = Intensity of light from source * ( \frac{4 π {r}^{2}}{4 π {r}_{o}^{2}} )$$

$$where , r = dtan ( θ )$$

In theory, F(x)=F(x0) at light surface. But in practical there is still a power loss due to non-vacuum environment from the light source to the water surface. The formula of the subjection application addresses the loss issue by claiming that d is the distance from the light source to any depth of water. (but for simplicity, an angle of the light source is taken to be Pi). As the original light source is reduced by a smaller effective light radius (r) from the lamp, consumption of the light is usually as around 80% from an estimated light source at an angle of around 160 degrees.

Intensity at depth=intensity*disount by air refraction*transmittance % of solution

F(x)=F(x₀)*1/nₐᵢᵣ*T

where n is the refractive index of air only if the distance from light source to surface is larger than depth in question. If not, n shall be refractive index of solution. And T is the natural transmittance of solution as a percentage.

### EXAMPLES

In an example, if transmittance of phenol at 254 nm is less than 25%, at a lamp from 5 cm the refractive index of air with the discounted intensity from source would be used. Therefore, F(x)=1/n*(25/100)*0.8 or less than 19% of the original UV light intensity actually got transmitted to the surface of the light. Hence the intensity at liquid depth to distance formula starts from the light source rather than on the top surface of liquid. Hence, lighting effects such as resultant intensity on the surface of the liquid and the surface area exposed to the intensity influences resultant polymerization of the phenols in the solution.

Hence, if the light source is located above the water surface (e.g., 1 cm), then an effective practical power is almost only ⅓ of the actual radiant power from the light source, due to light intensity not perpendicular or uniformly pointed downwards, lost to environment and reflected off surface. But as the depth is usually very shallow, the formula above is used, instead of the general equation which takes into account of the extinction coefficient of the water, considering the distance from light source to water surface is larger than the total depth of the water in the subject application.

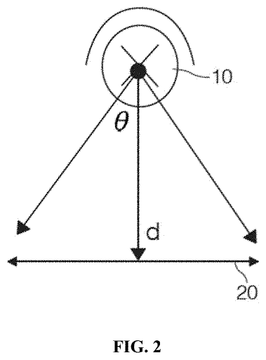

The FIG. 2 shows a schematic figure of the light source 10 emitting ultraviolet (UV) light to water surface 20. The linear relationship shown in the aforementioned formula works within the context of less than 15 cm from light source 10 to reaction surface from a concentrated fluorescent light source.

Although maybe demulsified in the waste water, the phenolic compounds could be substantially assumed to be negligible as compared to a distance of the ultraviolent (UV) light to a surface of the waste water. In addition, the waste water becomes more and more clean when circulated back into the ultraviolet (UV) reactor; and the light penetration efficiency is improved accordingly. As a result, less phenolic compounds would be left in the waste water as more and more phenolic compound undergo the photocatalytic oxidation in the ultraviolet (UV) reactor.

In some implementations, the concentration is tested via chemical oxygen demand (COD). The phenolic compounds are measured reference method B. ISBN: 0117519154, in which the phenolic compounds are oxidized by digesting the waste water (i.e., heating the waste water in vial with together sulfuric acid and potassium dichromate). Mercuric sulfate is added to suppress any chloride interference. The phenolic compounds are oxidized by potassium dichromate during the digestion; meanwhile potassium dichromate is reduced to chromate which is then is measured colorimetrically. As a result, the content of phenolic compounds in the vial is calculated from the amount of chromate and is expressed in a unit of milligrams per liter (mg/L).

The process optionally includes a step of adding an acid solution (such as sulfonic acid solution) into the waste water before exposing the waste water to the ultraviolet (UV) light.

The process optionally includes a step of pre-treating the waste water before the step of adding the catalyst. In the pre-treating step, heavier solids (such as sands) are removed from the waste water by any known physical separation technologies such as physical separation method and filtration method; and lighter substances (such as oily substances) are also removed from the waste water by any known physical separation technologies such as a mechanical scrapper.

In some implementations, the step of pre-treating the waste water may include a procedure of adding a demulsifier (also known as emulsion breaker) for separating emulsions formed by the oily substances in the waste water. Examples of the demulsifiers may include such as but are not limited to acid/base catalyzed phenol-formaldehyde resins, epoxy resins, polyamines, polyols, dendrimer, and so on. As a result, the oily substance after separation floats to a surface layer of the waste water and be removed by the mechanical scrapper much more easily. Meanwhile, a light penetration problem for dark liquids or solutions in the ultraviolet-visible spectroscopy is simplified to a relationship of light distance to a surface of the liquid or solution as opposed to light penetration efficiency. The process optionally includes a step of temporarily storing treated waste water after removing the insoluble sediments from the waste water.

The process optionally includes a step of recycling the treated waste water for removing remaining phenolic compounds in the treated waste water. The recycling of treated waste water would enhance light penetration efficiency of the ultraviolet (UV) light in the ultraviolet (UV) reactor and gradually improve the controlled photocatalytic oxidation of the phenolic compounds in the waste water.

As a whole, the process of treating phenolic compounds in the waste water with the oxidation system is cheaper and more efficient compared with current methods. A typical effluent experimented in the present application relates to more than 92 wt % pure phenolic content, with total phenolic concentration ranging between 5-10 wt %, and chemical oxygen demand (COD) values typically more than 10% to a maximum recorded value of 22%.

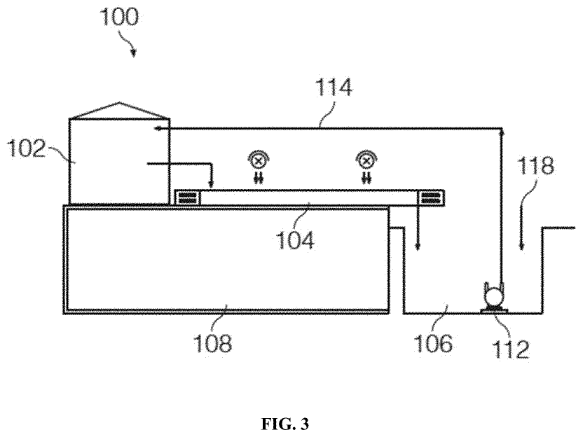

FIG. 3 illustrates a schematic diagram of an oxidation system 100. The oxidation system 100 includes a chemical dosing tank 102, an ultraviolet (UV) reactor 104 and a sedimentation tank 106 communicatively coupled in sequence. The chemical dosing tank 102 is located at a higher level than the ultraviolet (UV) reactor 104 such that the waste water flows from the chemical dosing tank 102 automatically to the ultraviolet (UV) reactor 104 under the gravity. Similarly, the ultraviolet (UV) reactor 104 is located at a higher level than the sedimentation tank 106 for the same purpose. Catalyst (not shown) and may be an acid solution is also added into the waste water in the chemical dosing tank 102. The ultraviolet (UV) reactor 104 has a tray-like configuration for controlling the photocatalytic oxidation of the phenolic compounds to quinones only. Multiple ultraviolet (UV) light sources 110 are installed over the ultraviolet (UV) reactor 104 for providing ultraviolet (UV) light to the waste water. Preferably, the multiple light sources 110 are evenly distributed across the ultraviolet (UV) reactor 104 for leading the photocatalytic oxidation of the phenolic compounds more homogeneously in the waste water. As a result, the waste water is turned into treated waste water with less phenolic compounds after the ultraviolet (UV) reactor. In addition, the arrow 118 shows an addition of catalysis into the sedimentation tank 106 either manually or automatically. The other arrows show flowing direction of the waste water in the oxidation system 100, i.e., firstly from the chemical dosing tank 102 to the ultraviolet (UV) reactor 104; secondly from the ultraviolent (UV) reactor 104 to the sedimentation tank 106; and finally, from the sedimentation tank 106 back to the chemical dosing tank 102 to complete a cycle of the process.

The oxidation system 100 further includes a chassis 108 for supporting the chemical dosing unit 102 and the ultraviolet (UV) reactor 104. A submerged pump 112 is installed in the sedimentation tank 106. The submerged pump 112 is communicatively coupled to a recycling channel 114 which connects the sedimentation tank 106 and the chemical dosing tank 102. As a result, the treated waste water could be recycled from the sedimentation tank 106 back to the chemical dosing unit 102 for one or more rounds of the process for further reducing concentration of the phenolic compounds via the photocatalytic oxidation.

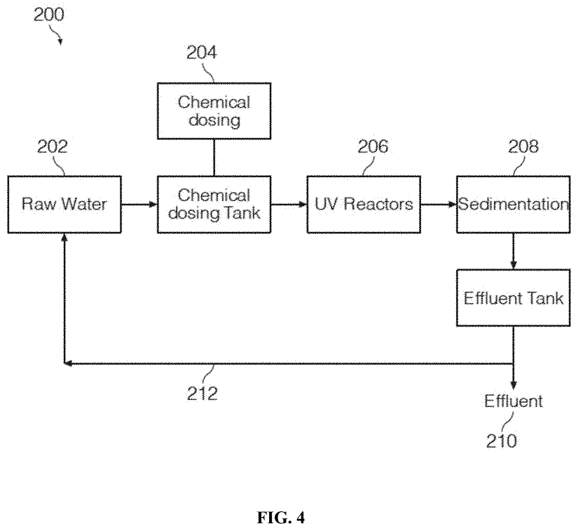

FIG. 4 illustrates a process flow 200 of treating the waste water. The process flow 200 includes a first step 202 of retrieving raw water having a high concentration of phenolic compounds. The raw water may come from industrial site of 4, 4′-(propane-2, 2′-diyl) diphenol or well known as bisphenol. A (abbreviated as BPA). It is synthesized by the condensation of acetone with two equivalents of phenol. Such a reaction requires a strong acid (such as HCl) to be used as a catalyst. It is very efficient and more than 65% of the dissolved phenolic compounds may be removed from the waste water. Industrially an excess of the phenolic compounds ensures complete condensation.

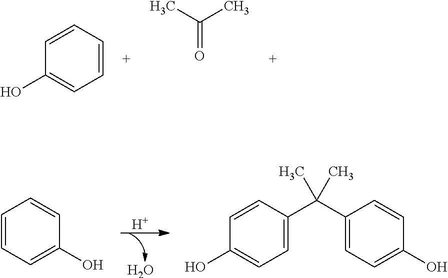

The process flow 200 includes a second step 204 of dosing the catalyst (such as chlorine-based compounds) into the raw water in the chemical dosing tank 102. Acid solution (such as sulfonic acid solution) would be also added into the chemical dosing tank 102 if the raw water has a pH outside the weak acidic range (i.e., 4-7). The dosing chemicals (catalyst, acids and others) are preferably mixed homogenously in the chemical dosing tank 102.

The process flow 200 includes a third step 206 of conducting a controlled photocatalytic reaction of a first portion of the phenolic compounds to quinones under ultraviolet (UV) light generated from the ultraviolet (UV) light sources 110 installed in the ultraviolet (UV) reactor 104. While a second portion of the phenolic compounds is left unreacted in the ultraviolet (UV) reactor 104. Then the quinones would react with the unreacted phenolic compounds to produce sediments of oligomers or even polymers which are not soluble in the waste water. Therefore, the oligomers or even polymers are suspended in the waste water or even precipitated from the waste water.

The process flow 200 includes a fourth step 208 of removing the insoluble sediments from the waste water in the sedimentation tank 106. Any known chemical separation method (such as adding flocculants) and/or physical separation method (such as filtering) is applicable to the sedimentation tank 208 for the purpose of removing the sediments.

The process flow 200 includes a fifth step 210 of testing the waste water in an effluent tank 116 which temporarily stores the treated waste water. If the waste water contains less phenolic compounds and thus meets an effluent requirement, the treated waste water would flow out of the oxidation system 100 as an effluent. If the waste water still contains an excess of phenolic compounds more than the effluent requirement, the process flow 200 includes an alternative step 212 of discharging the waste water back to the raw water and repeat the process flow 200 to further reduce the concentration of the phenolic compounds in the waste water.

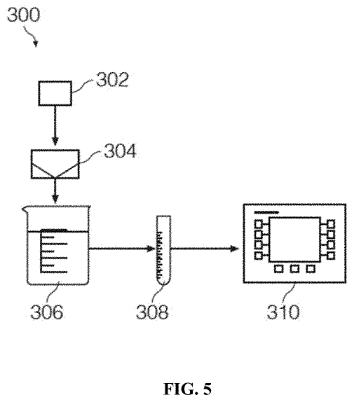

FIG. 5 illustrates a schematic diagram of testing flow 300 of the concentration of the phenolic compounds in the waste water via ultraviolet (UV) spectrometer. The testing flow 300 includes a first step of collecting a raw sample 302 of the waste water before the chemical dosing tank 102 or of the treated waste water after the sedimentation tank 106. The testing flow 300 includes a second step of filtering the sample collected in the first step in order to remove insoluble foreign materials in the raw sample; and thus, a filtered sample 306 is obtained. For example, a micro-filter 304 having a pore size of 1 micron is used to filter insoluble foreign materials larger than 10 micrometers. The testing flow 300 includes a third step of diluting the filtered sample 306 into a diluted sample 310 if the concentration of the phenolic compounds in the filtered sample 306 is too high that goes beyond out of a reliable testing range. The testing flow 300 includes a fourth step of using the ultraviolet (UV) spectrometer 310 to test the concentration of the phenolic compounds in the diluted sample 308. The third step and fourth step may be repeated until a final result of the ultraviolet (UV) spectrometer 310 falls within a linear region of a calibration plot to obtain an accurate and reliable reading of the phenolic compounds in the diluted sample 308. A dilution factor is thus obtained in the third step. And finally, the concentration of the phenolic compounds in the filtered sample 306 is calculated from the reading by multiplying the dilution factor. In addition, chemical oxygen demand (COD) tests are conducted to check concentration of the phenolic compounds in the treated waste water.

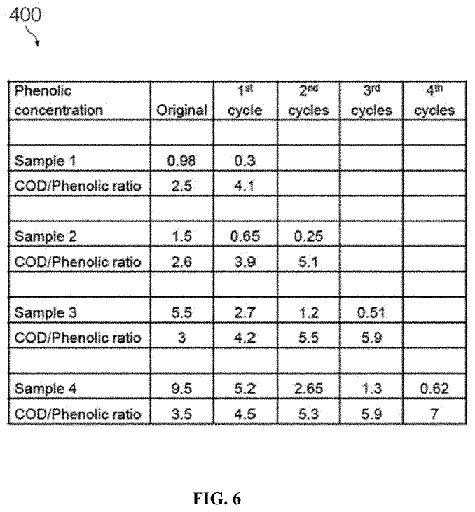

FIG. 6 illustrates a table of experimental results 400 of the oxidation system 100. A total of four samples are treated and tested in the experiment. For each sample, an original concentration is measured for the raw sample or filtered sample; and the concentration is also tested after each cycle of treatment with the oxidation system 100 using the process flow 200 as described above. In addition to the concentration, chemical oxygen demand (COD)/Phenolic ratio is also calculated and listed in the table. The COD/Phenolic ratio is used to indicate the controlled photocatalytic oxidation of the phenolic compounds in the samples. The COD/Phenolic ratio should be in a range of 5 to 6 in order to oxide the phenolic compounds substantially to quinones and almost no other forms of oxidized products.

For sample 1, the original concentration and the concentration after a first cycle of treatment are 0.98 and 0.3 ppm or milligrams per liter (mg/L), respectively. Accordingly, the COD/Phenolic ratios are 2.5 and 4.1, respectively. For sample 2, the concentration is lowered from 1.5 to 0.25 ppm after two cycles of treatment; and the COD/Phenolic ratio is controlled at 5.1. For sample 3, the concentration is lowered from 5.5 to 0.51 ppm after three cycles of treatment; and the COD/Phenolic ratio is controlled at 5.9. For sample 4, the concentration is lowered from 9.5 to 0.62 ppm after two cycles of treatment; and the COD/Phenolic ratio is controlled at 7.

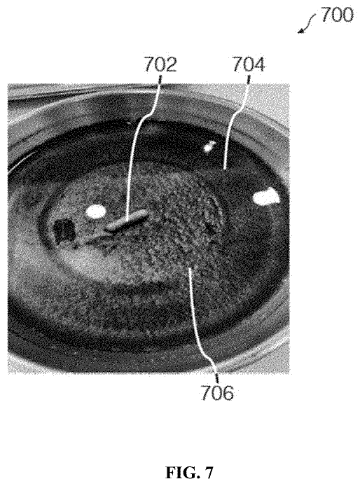

FIG. 7 shows a photo of the experiment results performed in a basin 700. The waste water 706 containing the phenolic compounds after the treatment is firstly mixed with the flocculent, then stirred with a stirrer 702 and finally left static for 15 minutes for brown sediments 704 (i.e., insoluble oligomers and/or polymers) to settle down to a bottom of the basin 700.

In summary, the controlled photocatalytic oxidation converts the phenolic compounds in the waste water into solid sediments of oligomers and even polymers known as phenoquinones in the ultraviolet (UV) reactor. The controlled photocatalytic oxidation process typically lasts around two to two and half (i.e., 2-2.5) hours which would remove about 60-65% of the phenolic compounds in the waste water. In a total, a single cycle typically lasts around five hours, including preparation of an influent to have a proper pH and a balance of the catalyst concentration, the ultraviolet (UV) light-controlled oxidation, separation of the oligomers and polymers from the waste water, determination whether a resultant effluent meets phenolic concentration requirements, and discharge of the resultant effluent. The resultant removal of the phenolic compounds in the waste water through the process could reach as high as 70%.

In particular, one of the factors contributing in higher % of the polymers is formation of insoluble chlorine complexes formed out of the phenolic compounds present in the solution, thereby forming the polymers at the beginning of a series of chemical reactions in the reactor. Second factor relates to aldehyde functional groups present in the dosed coagulant forming the large clusters of phenolic polymers during the ultraviolet (i.e. UV) lighting. Therefore, the resultant polymers are a mix of solid phenolic complexes.

As a result, waste water having a high concentration of phenolic compounds could be treated or processed with the oxidation system 100. The experiments show that the concentration of phenolic compounds could be as high as 50,000 to 110,000 parts per million (ppm) with presence of acetaldehyde having a concentration of 20 parts per million (ppm). Therefore, the present application provides a process which favors the formation of phenolic derived compounds (intermediate-quinone) over other intermediate compounds such as carbon dioxide and water, followed by polymerization between the quinone and the remaining untreated phenolic compounds.

In the application, unless specified otherwise, the terms “comprising”, “comprise”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Numerous embodiments of the invention are possible. The previous exemplary embodiments are intended to merely illustrate, and not limit, the breadth and depth of embodiments that can fall within the scope of the appended claims and future claims, which define the invention. For example, the apparatus will be scaled to accommodate different flow rates of the water to be treated or impregnated. The chemical flow rates, hence the concentration of the chemistry, and the pressure in the system may be adjusted depending on the contaminants to be treated and/or the particular application.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

### REFERENCE NUMERALS

10 light source;
20 water surface;
100 reduction system;
102 chemical dosing tank;
104 ultraviolet (UV) reactor;
106 sedimentation tank;
108 chassis;
110 ultraviolet (UV) light source;
112 submerged pump;
114 recycling channel;
116 effluent tank;
118 arrow;
200 process flow;
202 first step;
204 second step;
206 third step;
208 fourth step;
210 fifth step;
212 alternative step;
300 testing flow;
302 raw sample;
304 micro-filter;
306 filtered sample;
308 diluted sample;
310 ultraviolet (UV) spectrometer;
400 experimental results;
700 basin;
702 stirrer;
704 brown sediments;
706 waste water containing phenolic compounds

1. An oxidation system for removing phenolic compounds from waste water, the oxidation system comprising:
a chemical dosing tank having a consumable catalyst added therein;
an ultraviolet reactor communicatively coupled to the chemical dosing tank, the ultraviolet reactor comprising a plurality of ultraviolet light sources and a controlling mechanism enabling a controlled lateral flow of the waste water across the ultraviolet reactor to a pre-determined speed for providing controlled oxidation of the phenolic compounds into the phenol-derived compounds, and polymerization of the phenol-derived compounds and unreacted phenolic compounds into insoluble sediments; and
a sedimentation tank communicatively coupled to the ultraviolet reactor configurated to remove the insoluble sediments from the waste water.

2. The oxidation system of claim 1, further comprising:
a pre-treatment mechanism communicatively coupled before the chemical dosing tank.

3. The oxidation system of claim 1, wherein
the chemical dosing tank locates higher than that of the ultraviolet reactor enabling automatic gravitational flow of the waste water from the tank into the ultraviolet reactor.

4. The oxidation system of claim 1, further comprising:
formation of insoluble chlorine complex polymers out of the phenolic compounds present in the wastewater due to addition of the consumable catalyst.

5. The oxidation system of claim 1, wherein
the catalyst is chlorine-based and ultraviolet-activated.

6. The oxidation system of claim 1, wherein
an even distribution of the plurality of the ultraviolet light sources across the ultraviolet reactor carrying homogeneous photocatalytic oxidation of the phenolic compounds in the waste water.

7. The oxidation system of claim 1, further comprising:
an effluent tank communicatively coupled to the sedimentation tank for temporarily storing treated effluent.

8. The oxidation system of claim 1, further comprising:
photo-catalytic activation configured to generate hydroxyl radicals in the waste water oxidizing the phenolic compounds into the phenolic derived compounds.

9. The oxidation system of claim 1, the chemical dosing tank further comprising:
a number of chemicals selected from a group selected from demystifiers, coagulants flocculants, acid solutions, sulfuric acid, chlorine based, and combinations thereof.

10. The oxidation system of claim 7, further comprising:
a recycling mechanism communicatively coupled between the effluent tank and the chemical dosing tank for returning treated waste water back to the chemical dosing tank.

11. A process for removing phenolic compounds from waste water, comprising the steps of:
adding a consumable catalyst into the waste water;
oxidizing the phenolic compounds into insoluble sediments under controlled ultraviolet light (photocatalytic oxidation) conditions; and
removing the insoluble sediments from the waste water.

12. The process of claim 11, further comprising:
activating the catalyst by the ultraviolet light for generating hydroxyl radicals in the waste water, the hydroxyl radicals having oxidizing power enough to oxidize the phenolic compounds to phenolic derived compounds, followed by polymerizing the phenolic derived compounds and the remaining unreacted phenolic compounds to form the insoluble sediments.

13. The process of claim 11, further comprising:
adding an acid solution into the waste water before exposing the waste water to the ultraviolet (UV) light.

14. The process of claim 11, further comprising:
removing foreign materials (solids or oily substances) in the waste water before adding the catalyst.

15. The process of claim 11, further comprising:
adding a chlorine-based consumable and ultraviolet-activating catalyst into the waste water in the chemical dosing tank.

16. The process of claim 11, further comprising:
polymerizing the phenolic compounds and the phenolic-derived compounds at a temperature ranging between 45° C. and 55° C. in the waste water.

17. The process of claim 11, further comprising:
storing treated waste water temporarily after removing the insoluble sediments from the waste water.

18. The process of claim 11, further comprising:
recycling the treated waste water for removing the remaining phenolic compounds in the treated waste water.

19. The process of claim 11, further comprising:
controlling a lateral flow of the waste water across the ultraviolet reactor to a pre-determined speed to provide controlled oxidation of the phenolic compounds to the phenolic derived compounds.

20. The process of claim 11, further comprising:
adding flocculent to the treated waste water for clustering the insoluble sediments derived from the phenolic compounds in the waste water.
